(19) United States
(12) Patent Application Publication
(10) Pub. No.: US 2024/0378250 A1
(43) Pub. Date: Nov. 14, 2024

(54) PREDICTIVE SOURCING PLATFORM

(71) Applicant: Wells Fargo Bank, N.A., San Francisco, CA (US)

(72) Inventors: Jasen Wayne Garrett, Urbandale, IA (US); Allison Rae Bendert, New York, NY (US); Jennifer L. Merrill, Pineville, NC (US); Mohit Gupta, Karnal (IN); Matthew S. Shejen, Matthews, NC (US); Dean A. Furness, Saint Charles, IA (US); Carlos Rafael Pivaral, Gilbert, AZ (US)

(21) Appl. No.: 17/452,298

(22) Filed: Oct. 26, 2021

(51) Int. Cl. G06F 16/9535; G06F 16/9536; G06N 20/00

(52) U.S. Cl. CPC G06F 16/9535; G06F 16/9536; G06N 20/00; G06Q 10/063112; G06Q 10/06398

(57) ABSTRACT

Systems and techniques for a predictive sourcing platform are described herein. User story data may be received that includes user story attributes that describe constraints for completion of a task of the user story and a points value for the user story. Resource profile data may be received that includes resource attributes that describe the resource. The user story attributes and the resource attributes may be evaluated using a predictive machine learning model. A set of resources may be selected from the output of the evaluation using the predictive machine learning model. A selection of a resource from the set of resources may be received. It may be identified that the user story is complete. The points value may be assigned to a profile of the selected resource.

### TECHNICAL FIELD

Embodiments described herein generally relate to computer-assisted resource allocation and, in some embodiments, more specifically to a predictive sourcing platform for resource allocation using machine learning and gamification.

### BACKGROUND

Resource sourcing may include allocating a resource to a requirement. A requirement may be a demand for a particular resource needed to complete a task. The requirement may include metrics or attributes of a resource based on the task to be completed. A resource may be sourced for the requirement by matching metrics or attributes of a resource to the metrics or attributes of the requirement.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of an example of an environment and a system for a predictive sourcing platform, according to an embodiment.

FIG. 2 illustrates a data flow diagram of an example of multi-system enterprise data collection for a predictive sourcing platform, according to an embodiment.

FIG. 3 illustrates an example of a user interface application view for a predictive sourcing platform, according to an embodiment.

FIG. 4 illustrates an example of a user interface application user view for a predictive sourcing platform, according to an embodiment.

FIG. 5 illustrates an example of a user interface application product manager view for a predictive sourcing platform, according to an embodiment.

FIG. 6 illustrates an example of a user interface application leadership view for a predictive sourcing platform, according to an embodiment.

FIG. 7 illustrates an example of an artificial intelligence flow diagram for a predictive sourcing platform, according to an embodiment.

FIG. 8 illustrates an example of gamification for a predictive sourcing platform, according to an embodiment.

FIG. 9 illustrates an example of a process for user story matching for a predictive sourcing platform, according to an embodiment.

FIG. 10 illustrates an example of a process for gamification for a predictive sourcing platform, according to an embodiment.

FIG. 11 illustrates an example of a method for gamification for a predictive sourcing platform, according to an embodiment.

FIG. 12 illustrates an example of a method for a predictive sourcing platform, according to an embodiment.

FIG. 13 is a block diagram illustrating an example of a machine upon which one or more embodiments may be implemented.

### DETAILED DESCRIPTION

Technology projects may require specialized resources including personnel with specific skillsets. Requirements may define the required resources for a project or a task to be completed as a part of a project workflow. It may be difficult for a project owner to define the project requirements and to identify resources within an organization that have the skill necessary to complete the project. All of the skills and interests of personnel within the organization may not be documented or be otherwise readily apparent to a project manager. Thus, the human project manager may be unable to identify resources to be assigned to a project. Furthermore, an organization may have other goals beyond the technical requirements of a project that may be considered when selecting project resources. For example, an organization may wish to promote career development by selecting resources that have an interest in a skillset, but may not have deep experience in the skill area. The organization may also wish to promote diversity and may select personnel to create a diverse project team or may select personnel that have an interest in a particular diversity area for a project.

Conventional resource selection and allocation techniques may allow resource data to be stored and compared to project requirements to match resources to projects. However, the conventional techniques are unable to discover user stories that define project requirements, discover resource skill sets, and promote participation of resources to create a rich dataset of resource profiles. The user stories may be promoted within the organization to allow prospective resources to express an interest in a project that may be used in the selection analysis. The systems and techniques discussed herein find and match a resource to a project using a data driven approach and the resource profiles. More accurate resource selection and allocation decisions are made for projects using the data driven approach that provides better multidimensional resource to project matches than human managers or conventional skill to project matching techniques may provide. In addition, because resource profiles may be evaluated throughout the organization, a multidisciplinary team may be generated for a project rather than a team consisting of member of the team of a single manager.

The solution discussed herein benefits multiple personas within an organization bringing together Engineers, Product Owners, and Technology Leaders to solve organizational problems with modern engineering solutions. For example, an Engineer may want to: develop innovative solutions to a variety of problems and participate in stretch assignments that challenge him/her, share his/her code solutions with other internal developers, volunteer his/her skillset to solve outstanding problems within the organization, use his/her excess capacity to upgrade my development skills through targeted training, network with technologists outside his/her day job and shadow more experienced engineers and mentor less experienced employees, and engage with Team Member Networks.

In another example, a Product Owner/Application Team, may want to: post user stories even if the work falls outside his/her team's current scope, match and engage engineers with the right skillset who will help complete his/her user stories, use internal engineering talent to create new and impactful product features that will benefit the business, and utilize excess capacity from engineers to speed up the delivery of product user stories.

In yet another example, a Technology Leader, may want to: engage employees in organizational goals and priorities to increase productivity, view his/her team's contributions to user stories and identify top performers, encourage professional development in order to retain top talent, and promote diversity and inclusion.

The systems and techniques discussed herein provide an integrated inner sourcing platform driven by gamification and artificial intelligence (AI) algorithms that proactively match employee skills to user stories. The system matches product and application teams with engineers who are interested in applying their unique skillsets seamlessly through the inner sourcing platform. The AI powered inner sourcing platform automatically predicts a match between resource profiles and user stories to build innovative, never-done-before, product features that improve employee and customer experiences. Engineers, Product Owners, and Technology Leaders are leveraged to design solutions for business outcomes and the inner sourcing platform enables engagement, career development, and personal development for the resources. Predicting where engineering talent will be most productive and promoting cross functional self-forming teams may lead to faster time to market for development efforts. Untapped engineering talent may be harnessed to create new features and encourage employees to increase their engineering skills. Team Member Networks may be leveraged to provide historically underrepresented groups with new opportunities increase their engineer skills. A machine learning model may be used that includes features that provide stretch assignments (e.g., less than optimal skill matches, etc.) so resources may build a diverse engineering skillset. An interface is provided to enable resources to nominate themselves to complete user stories in a self-service manner to further facilitate a self-organizing team infrastructure.

Data is collected from multiple electronic data sources to utilize an AI algorithm to predict a match between a resource profile and a user story. For example, an automated data collection agent of the inner sourcing platform may connect to a variety of platforms that include data that may be used to build a skill profile for a resource. For example, data may be collected from JIRA®, ATOM, IBM® Cloud Foundry, human resources skills inventory database, education databases, diversity and inclusion data, personnel management data, etc. The collected data may populate resource profiles and may be input to one or more machine learning and AI algorithms to predict and allocate resources that may be candidates for project tasks. Additional data sources may be accessed to build better predictive models. Furthermore, feedback data may be collected for predictions that may be fed back into the machine learning system to refine the prediction models. Additionally or alternatively, data may be collected and evaluated for external resources to identify resources to accommodate skill gaps within the organization.

Dashboards may be generated that seamlessly display user story matches, progress toward process improvement initiatives (e.g., Six Sigma, etc.), engagement with Team Member Networks (TMNs), etc. to enhance user experience. Gamification techniques are used to increase engagement and make user stories easier to manage. Fun, compelling, and interactive elements from games are applied to encourage participation of resources to capture skill, interest, diversity, and other personal data that may not be available in electronic data sources. Gamification may also increase participation of managers for initiating user stories to identify resources.

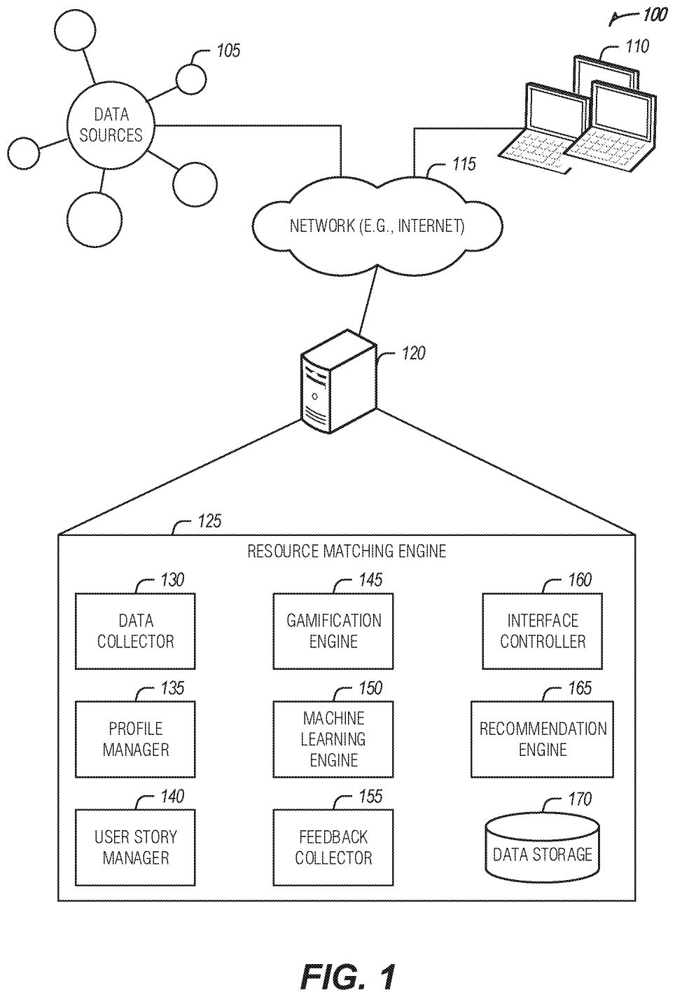

FIG. 1 illustrates a block diagram of an example of an environment 100 and a system 125 for a predictive sourcing platform, according to an embodiment. The environment 100 may include a variety of data sources 105 (e.g., project data sources, development data sources, human resources data sources, application data sources, etc.) that may include data about resources. The data sources 105 may be communicatively coupled to a server 120 (e.g., a standalone serve, a service cluster, a cloud computing platform, etc.) via a network 115 (e.g., the internet, a wired network, a wireless network, etc.). User devices 110 (e.g., a desktop computer, a laptop computer, a tablet computing device, a mobile computing device, etc.) may be used by users to interact with the system 125 to input data and receive output data. The user devices 110 may be communicatively coupled to the server 120 via the network 115.

The server 120 may include the system 125. In an example, the system 125 may be a resource matching engine. The system 125 may include a variety of components such as a data collector 130, a profile manager 135, a user story manager 140, a gamification engine 145, a machine learning engine 150, a feedback controller 155, an interface controller 160, a recommendation engine 165, and data storage 170 (e.g., a structured database, an unstructured database, a graph network, etc.).

The data collector 130 may access the data sources 105 to obtain data about resources (e.g., personnel, etc.) including work product, skills inventories, educational data, work experience, and other data elements that may be indicative of skills and experience levels of a resource. For example, Helen may have created source code for an application that was part of a previous development project. The source code, project data, timelines, and other data may be collected from project data sources, development data sources, and other data repositories that may include data about the contributions of Helen to the project. A human resources data source and other employer maintained data sources may be accessed by the data collector 130 to obtain a skill inventory, educational background, and other data about the experience and skills of Helen.

The profile manager 135 may generate a profile for Helen that based on the data collected from the various data sources. The profile may include attributes and metrics that are generated and calculated based on an evaluation of the data by the profile manager. For example, the project data for the previous project may indicate that the source code was written in C # and the code was developed over a six month period. The profile manager may calculate that Helen has an attribute of C # development and may assign an experience metric of six months based on the project data. The user may be provided with a user interface by the interface controller 160 that enables the user to provide some self-describing information including interests, diversity and inclusion data, career objectives, etc. The profile may be stored in the data storage 170.

The user story manager 140 may receive requirements and preferences for a task or set of tasks to be completed from a user device 110 that includes. The user story manager 140 may generate a user story based on the requirements and preferences. Furthermore, the user story manager 140 may evaluate project data or other data to automatically generate a base user story. The base user story may provide a framework that a user may use to generate a more complete user story to be submitted for resource fulfillment. A user story may include a variety of attributes including tasks to be completed, skills requirements, timelines, diversity and inclusion preferences/information, acceptability of slack skill matching that may enable less than optimal skill matches to enable career development and to meet diversity and inclusion preferences, etc. The user story may be stored in the data storage 170.

The gamification engine 145 may receive configuration information that includes a variety of preferences for providing users with game interactions that may include badges, leveling, rewards, and other incentives based on engagement with the system 125. For example, the gamification engine may be configured to issue a badge flower for user profiles and, as points or other metrics are achieved, petals of the badge flower may be populated with badges that correspond to achievements. For example, Helen may engage in two user stories that have an armed forces attribute and may be assigned an armed forces badge for display in a petal of the badge flower. In another example, the gamification engine 145 may be configured with a variety of levels with corresponding titles. As the user accumulates points for engaging in user stories or for accomplishing other tasks within the system 125. For example, Helen may have completed user story tasks with a total points value of nineteen and may receive a title of “Juggernaut.” The title may be displayed in the user profile of Helen and may be viewed by other users of the system when searching for Helen, receiving Helen as a predicted user story match, or searching for resources with skills similar to those found in the profile of Helen.

The gamification engine 145 may designate point values for user stories or user story tasks based on experience level required, the skill required, and other factors indicated by attributes of the user story. In an example, the points values may be predefined and may be assigned upon creation of a user story. In another example, a user creating the user story may be presented with a set number of points to distribute amongst tasks/skills of the user story and the points values may be designated based on the point allocations made by the user. In yet another example, the gamification engine 145 may work in conjunction with the machine learning engine 150 to learn points values for user story tasks/skills based on point allocations made by other users. The gamification engine 145 may work in conjunction with the user story manager 140 and the user interface controller 160 to display the recommended points value. The user may keep the recommended points value or may change the default points value suggested by the gamification engine 145.

The machine learning engine 150 may include a variety of machine learning and artificial intelligence algorithms for classifying, clustering, regression, density estimation, etc. The machine learning engine 150 may receive profile data and user story data as input from the data storage 170. The input may be processed by the machine learning engine 150 to predict resources corresponding with the profile that would be a good fit for a user story. A number of profiles may be predicted as a potential fit for the user story based on a probability calculated by comparing attributes and metrics of the profiles to requirements and preferences of the user story. For example, Helen may have six months of C # experience and may have an interest in armed forces projects. A user story may be identified that includes a requirement of four months of C # experience, a diversity tag of armed forces, and a requirement of six months of hypertext markup language (HTML) experience. Helen may be predicted to be a sixty-six percent match for the user story. Weighting and slack attributes may be assigned to requirements of a user story making the matching more complex than a one-to-one probability. Thus, if weighting and slack are applied wherein the requirement for HTML is relaxed if a resource has an interest in armed forces related projects, Helen may be predicted as a ninety percent match. This enables resources that may not have the hard skills to be selected if they have soft skills that are a good fit for a user story.

The recommendation engine 165 may receive the output of the machine learning engine 150 and may select a subset of the returned resource profiles for recommendation to a user story owner. For example, the recommendation engine may select the top ten results, a number of results included in the user story configuration, etc. In an example, the results may be ranked based on requirements and preferences matched or based on match closeness and may be provided in ranked order. In an example, the probability of a match may be replaced with a rank value in the recommended profile output. In another example, the recommendation engine 165 may work in conjunction with the interface controller 160 to present the selected profiles in random order to prevent the user story owner from selecting the first candidate based solely on rank. This may be enabled in conjunction with the gamification engine 145 as a gamification configuration option.

The interface controller 160 may generate a user interface for presentation to the user story owner that provides the list of predicted recommended candidates. The interface controller 160 may generate or update a user interface for presentation to users that enables the users to express an interest in a user story. The interest may be part of the input received and evaluated by the machine learning engine 150 to calculate a probability of a match between the user and the user story. The interface controller may work in conjunction with the feedback collector 155 to generate a feedback user interface for a user story owner to evaluate the recommendations presented to the user story owner. The feedback collector 155 may provide the feedback to the machine learning engine 150 and the machine learning engine 150 may use the feedback data to refine the prediction models used to generate the recommended resource list.

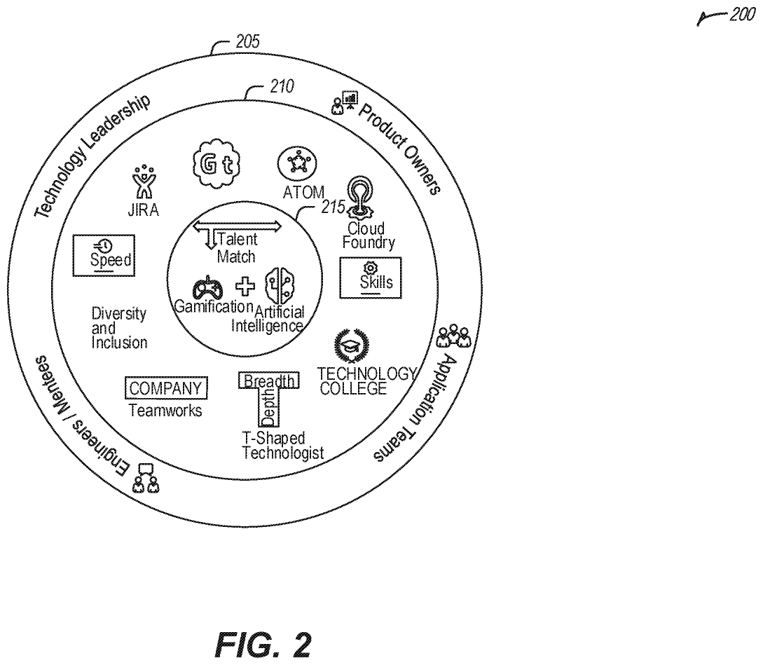

FIG. 2 illustrates a data flow diagram 200 of an example of multi-system enterprise data collection for a predictive sourcing platform, according to an embodiment. The data flow diagram 200 may provide features as described in FIG. 1. The predictive sourcing platform uses employee data from multiple enterprise applications to best match employee skills to user stories. The data flow diagram illustrates the flow of information from users 205 (e.g., technology leadership, product owners, application teams, and engineers/mentees) to a variety of data sources 210 and then to the predictive sourcing platform 215. As described in FIG. 1, data about the users 205 may be stored in the data sources 210 through use of the applications associated with the data sources, data maintained about the resources by an organization, etc. The predictive sourcing platform 215 may collect data from the data sources 210 and may use the data to calculate a probability used to predict whether a resource is a good fit for a user story (e.g., a project task, etc.).

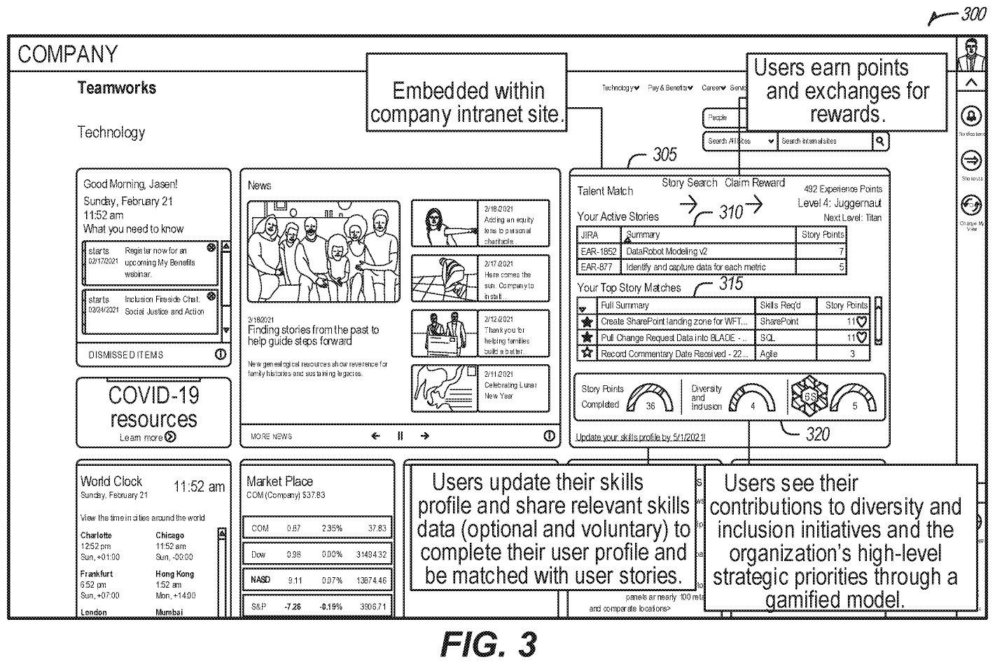

FIG. 3 illustrates an example of a user interface application view 300 for a predictive sourcing platform, according to an embodiment. The user interface application view 300 may provide features as described in FIGS. 1 and 2. The user interface application view 300 illustrates an embedded predictive sourcing platform interface 305 (e.g., as provided by the interface controller 160 as described in FIG. 1, etc.) displayed in a user web portal (e.g., a company intranet site, etc.). The embedded predictive sourcing platform interface 305 may include a variety of user interface elements. For example, the embedded predictive sourcing platform interface 305 may include a listing of active user stories 310 that may include descriptions of active user stories and a points value for the active user story (e.g., as provided by the gamification engine 145 as described in FIG. 1, etc.). This allows a user to quickly view user stories to which the user has been assigned and how many points they may expect to receive upon completion of the user story.

The embedded predictive sourcing platform interface 305 may include a list of story matches 315 that provide the user with a description of user stories that the user has been matched to, the skills needed for the user story, and a points value for participation in the user story. The embedded predictive sourcing platform interface 305 may include a dashboard 320 that may include visual representations in the form of gauges, badge flowers, and other graphical content that provides the user with progress status for gamification elements managed by the embedded predictive sourcing platform interface 305. For example, the user may be provided with a gauge that shows a current points total, a diversity and inclusion score, a badge flower with badges achieve and a gauge indicating progress towards new badges.

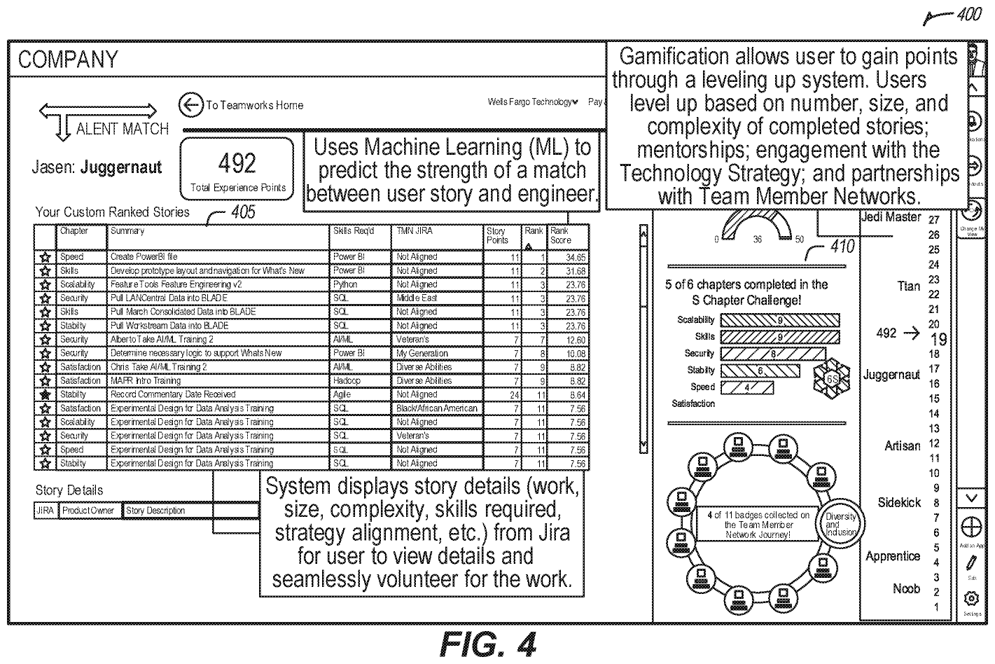

FIG. 4 illustrates an example of a user interface application user view 400 for a predictive sourcing platform, according to an embodiment. The user interface application user view 400 may provide features as described in FIGS. 1 and 2. The user interface application user view 400 provides a detailed display of user stories 405 that includes a chapter of a user story that indicates a stage of a user story (e.g., stability, scalability, etc.), a summary of the user story, skills required, a diversity or other group to which the user story is assigned, a number of points that may be earned by completing the user story, a rank of the user for the user story, and a rank score for the profile of the user to the user story. This information provides the user with an information to determine if a user story is a good fit for the user. The user can use the provided information to self-select a user story thereby expressing an interest in joining the team working on the user story. The user interface application user view 400 includes a gamification window 410 that provides a detailed view of the progress the user has made toward badges, challenges, titles, and other accomplishments that may result in rewards or recognition for the user.

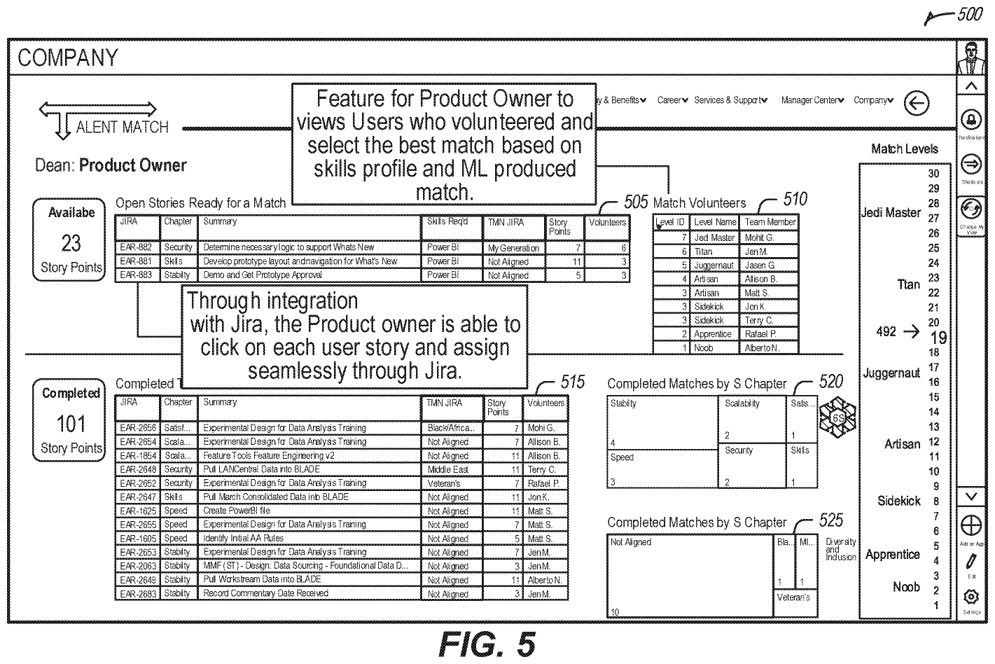

FIG. 5 illustrates an example of a user interface application product manager view 500 for a predictive sourcing platform, according to an embodiment. The user interface application product manager view 500 may provide features as described in FIGS. 1 and 2. The user interface application product manager view 500 provides a detailed view to a user story owner and includes a variety of user interface elements. The user interface application product manager view 500 includes open user stories that are ready for matching 505 that includes a list of the user stories create for the user that includes identification numbers for the user stories, chapters of the user stories, summaries of the user stories, skills required, a diversity or other group to which the user story is assigned, points for the user story, and a number of volunteers for the user story. The user interface application product manager view 500 includes a list of volunteers 510 that includes a level of the volunteers, a level title for the volunteers, an a name for the volunteers. The user interface application product manager view 500 includes a list of completed user stories including information about the user stories and team members that completed the user stories. The user interface application product manager view 500 includes a chapter information element 520 that includes numbers of matches completed for each chapter of a user story and a diversity and inclusion information element 525 that includes numbers of completed user stories for diversity or other groups.

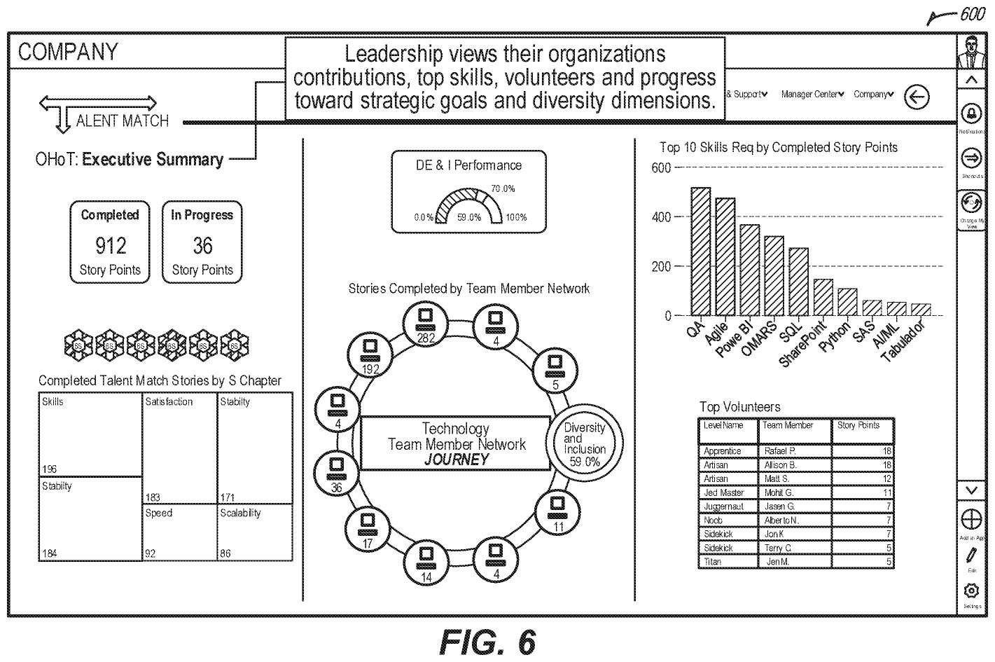

FIG. 6 illustrates an example of a user interface application leadership view 600 for a predictive sourcing platform, according to an embodiment. The user interface application leadership view 600 may provide features as described in FIGS. 1 and 2. The user interface application leadership view 600 may include interface elements that provide leadership users with a graphical representation of progress of the organization including user story initiation and completion, teams that are engaged in completing user stories, top skills, top volunteers, diversity and inclusion progress, etc. The user interface application leadership view 600 provides the leadership user with an easily digestible display of the health of the predictive sourcing platform based on engagement and goal achievement.

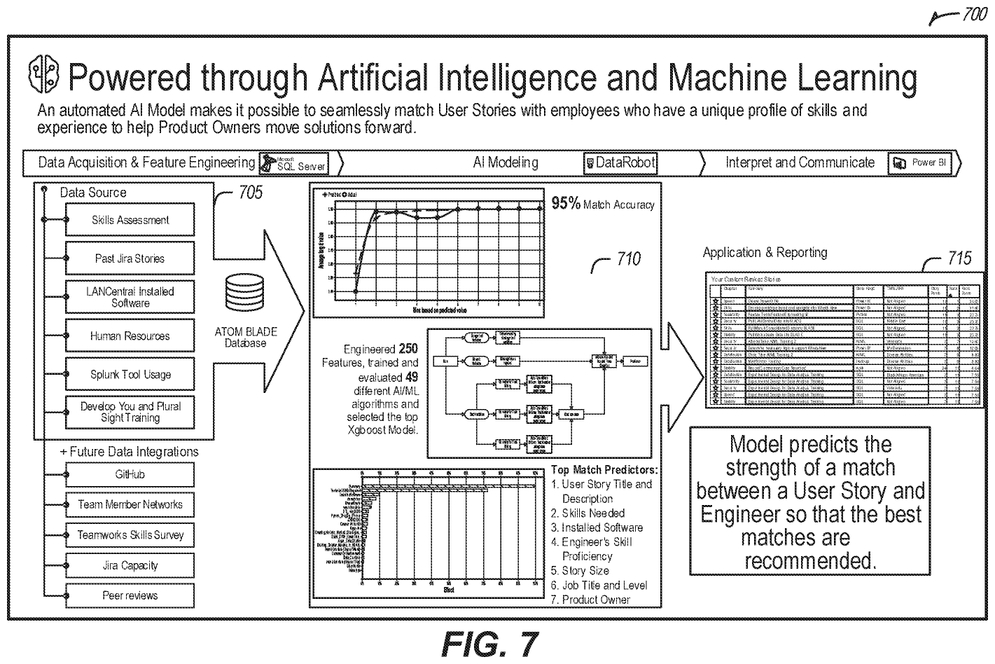

FIG. 7 illustrates an example of an artificial intelligence flow diagram 700 for a predictive sourcing platform, according to an embodiment. The artificial intelligence flow diagram 700 may provide features as described in FIGS. 1-6. The predictive sourcing platform is powered through artificial intelligence (AI) and machine learning (ML). An automated AI model makes enables seamless matching of user stories with resources who have a unique profile of skills and experience to help product owners move solutions toward completion. Data is collected from data sources 705 and used as training input for a machine learning engine 710. Features are extracted to build prediction models. The prediction models are compared to identify the most accurate prediction model. Features included in the prediction model may include user story title and description, skills required, installed software, skill proficiency, story size, job title and level, and product owner (e.g., user story creator, etc.). When a user story is submitted for matching, the attributes of the user story are received as input to the machine learning engine 710 along with attributes and metrics for resources. The inputs are evaluated using the prediction model to make fit predictions 715 for the user story. A set of resources is then presented to the product owner as recommended resources.

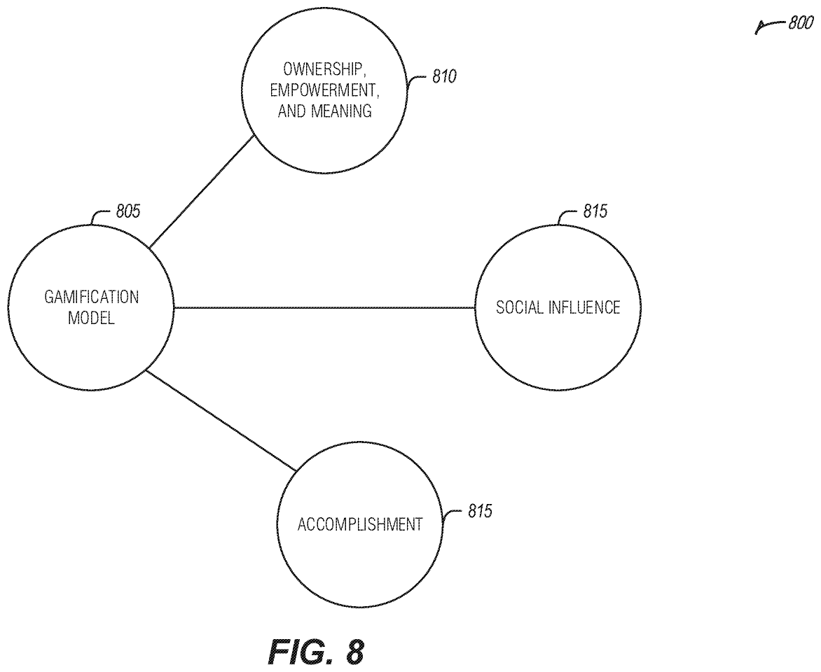

FIG. 8 illustrates an example of gamification 800 for a predictive sourcing platform, according to an embodiment. The gamification 800 may provide features as described in FIGS. 1-7. Gamification may apply a design framework (e.g., Octalysis, etc.). Core gamification drivers are identified and defined for target users of the predictive sourcing platform. A gamification model 805 may enable ownership, empowerment, and meaning 810. Resources (e.g., employees, etc.) own what they do and want to continuously improve because they are a part of something bigger than they are. Gamification aspects of the predictive sourcing platform including a skills profile view, a t-shaped skills development view, a diverse team and causes view, and a organizational goal view provide a visual representation to resources to provide the resources with a feeling of ownership, empowerment, and meaning. The resources may be provided with rewards including voting on user story priority, referral bonuses for referring resources for user stories, and avatars/avatar creation to provide the resources with an identity and persona for the predictive sourcing platform.

The gamification model 805 may enable social influence 815. Social influence 810 provides resources with an ability to interact with other employees, product owners, and team member networks and allows resource to share ideas and share knowledge. Rewards may be provided that include collaborative forums for idea exchange and shadowing opportunities that allow the resources to gain skill and learn areas where the resource may not have extensive experience. A mentoring and buddy program interface is provided to enable a resource to engage with other resources to expand skills and user story opportunities. A team member connection interface is provided to enable a resource to connect with diversity groups or other team member groups to share ideas and gain a deeper understanding of the team member groups.

The gamification model 805 may enable accomplishment 820. Accomplishment 820 provides a resource with a feeling of accomplishment to promote ongoing engagement with the predictive sourcing platform. Resources may earn points and may be rewarded for engagement. A rewards interface is provided that presents the user with rewards that may be exchanged for points the resource has earned. The resource may be presented with an interface that enables the user to level up based on points earned to promote a sense of working toward a goal to keep the resource engage. Similarly, the resource may be presented with a badges interface that displays badges earned based on completed user stories and criteria for earning additional badges. A leaderboard interface is provided that allows the resource to compare engagement with other users fostering competition and promoting continual engagement.

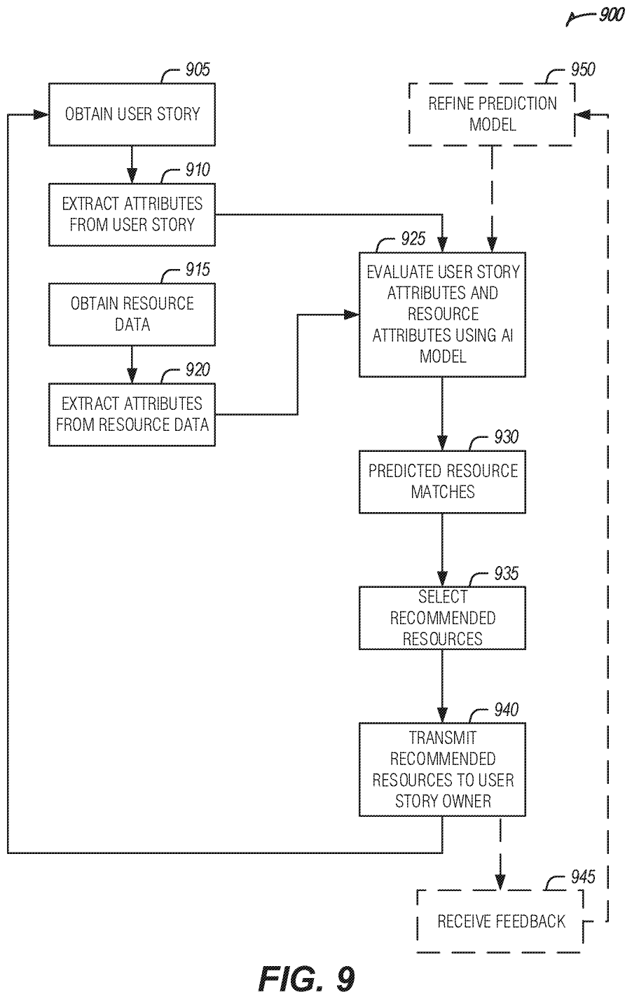

FIG. 9 illustrates an example of a process 900 for user story matching for a predictive sourcing platform, according to an embodiment. The process 900 may provide features as described in FIGS. 1-7.

At operation 905, a user story may be obtained. At operation 910, attributes may be extracted from the user story. For example, a title, description, required skills, etc. may be extracted from the user story.

At operation 915, resource data may be obtained. At operation 920, attributes may be extracted from the resource data. For example, resource skills, experience, interests, etc. may be extracted from the resource data.

At operation 825, the user story attributes and the resource attributes may be evaluated using an AI prediction model. At operation 930, predicted matching resources may be produced as output by a machine learning engine employing the AI prediction model. At operation 935, recommended resources are selected. For example, the top ten resources with the highest match probability may be selected. At operation 940, the recommended resources may be transmitted to the user story owner. For example, the recommended resources may be presented to a user interface of the user story owner with attributes of the recommended resources.

In an example, at operation 945, feedback may be received from the user story owner including ratings for the recommended matches. At operation 950, the AI prediction model may be refined based on the feedback received. For example, attribute weightings may be adjusted, a new model may be selected, or other modifications may be automatically made to the model to increase accuracy of prediction results.

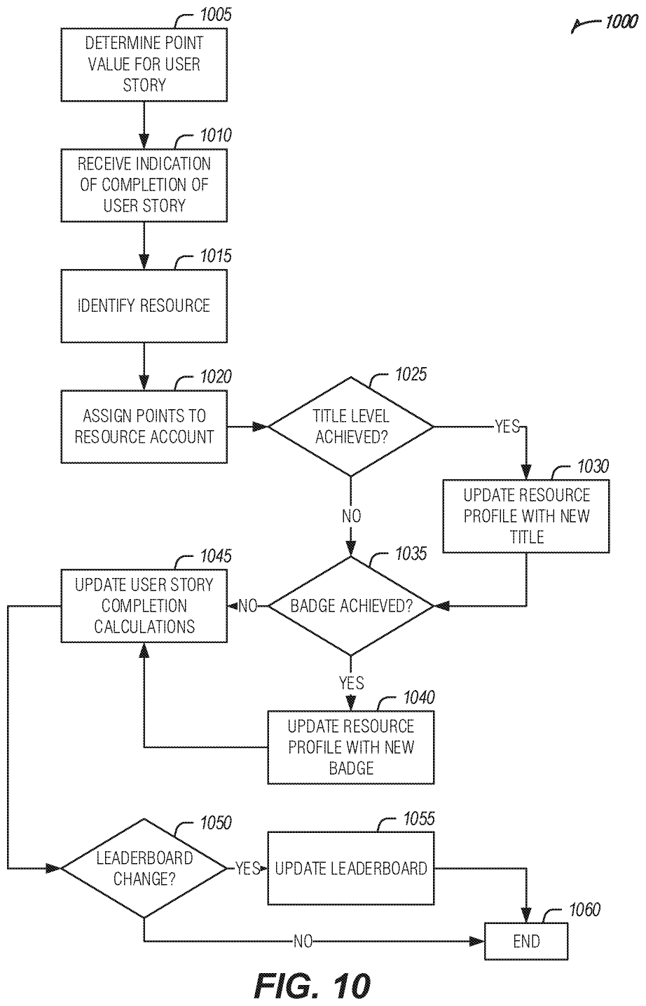

FIG. 10 illustrates an example of a process 1000 for gamification for a predictive sourcing platform, according to an embodiment. The process 1000 may provide features as described in FIGS. 1-8.

At operation 1005, a point value may be determined for a user story. At operation 1010, an indication may be received of completion of the user story. For example, a resource may be assigned to the user story and may have completed tasks associated with the user story.

At operation 1015, a resource may be identified that completed the user story. The points value for the user story may be assigned to an account for the resource. At decision 1025, it may be determined in a new title level has been achieved based on the assigned points. If so, the resource profile may be updated with the new title at operation 1030. For example, Helen may have a current title of Juggernaut and the new points assignment may qualify Helen for a Titan title and her profile may be updated to reflect the new title. If a new title has not been achieved, as determined at decision 1025, or upon update of the profile, it may be determined if a new badge has been achieved at decision 1035. If so, the resource profile may be updated with the new badge at operation 1040. If a new badge has not been achieved, as determined at decision 1035, or upon update of the profile, user story completion calculations are updated at operation 1045.

At decision 1050, it may be determined if there has been a leaderboard change. If so, the leaderboard is updated at operation 1055. If it is determined, at decision 1050, that the leaderboard has not changed or upon update of the leaderboard at operation 1055, the process 1000 ends at operation 1050.

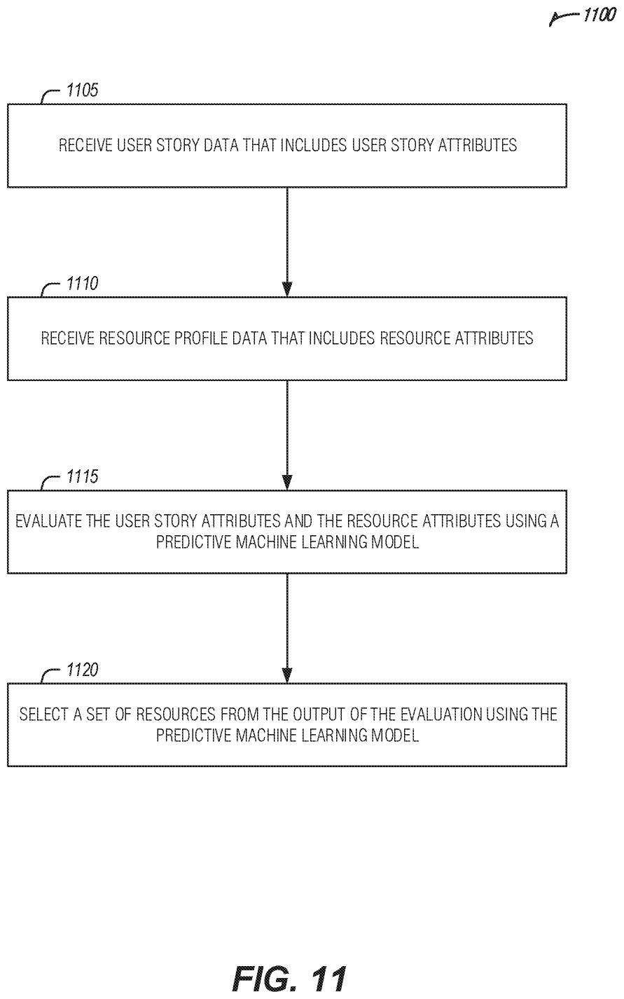

FIG. 11 illustrates an example of a method 1200 for gamification for a predictive sourcing platform, according to an embodiment. The method 1200 may provide features as described in FIGS. 1-10.

At operation 1105, user story data may be received that includes user story attributes that describe constraints for completion of a task of the user story and a points value for the user story. In an example, the attributes may include one or more of a user story title, a user story description, a user story owner identifier, skills, a user story chapter, a team member group identifier, or a user story complexity level.

At operation 1110, resource profile data may be received that includes resource attributes that describe the resource. In an example, resource profile data may be collected from a variety of data sources that include one or more of a human resources database, a development database, a project management database, an education records database, or a development repository. In an example, the resource profile data may include one or more of a resource identifier, a resource job title, a resource job level, a list of software installed on a computing device used by the resource, resource skills, and resource skill proficiency.

At operation 1115, the user story attributes and the resource attributes may be evaluated using a predictive machine learning model. In an example, the predictive machine learning model may be trained using data from the data sources and may be selected based on comparative accuracy of the selected model to non-selected models.

At operation 1120, a set of resources may be selected from the output of the evaluation using the predictive machine learning model. In an example, the set of resources may be selected based on relative probabilities among the output of the evaluation. In an example, the set of resources may be selected based on ranks of resource output by the evaluation. In an example, the set of resources may be transmitted to a user story owner via a graphical user interface. In an example, feedback may be received regarding the set of resources from the graphical user interface and the predictive machine learning model may be refined based on the received feedback.

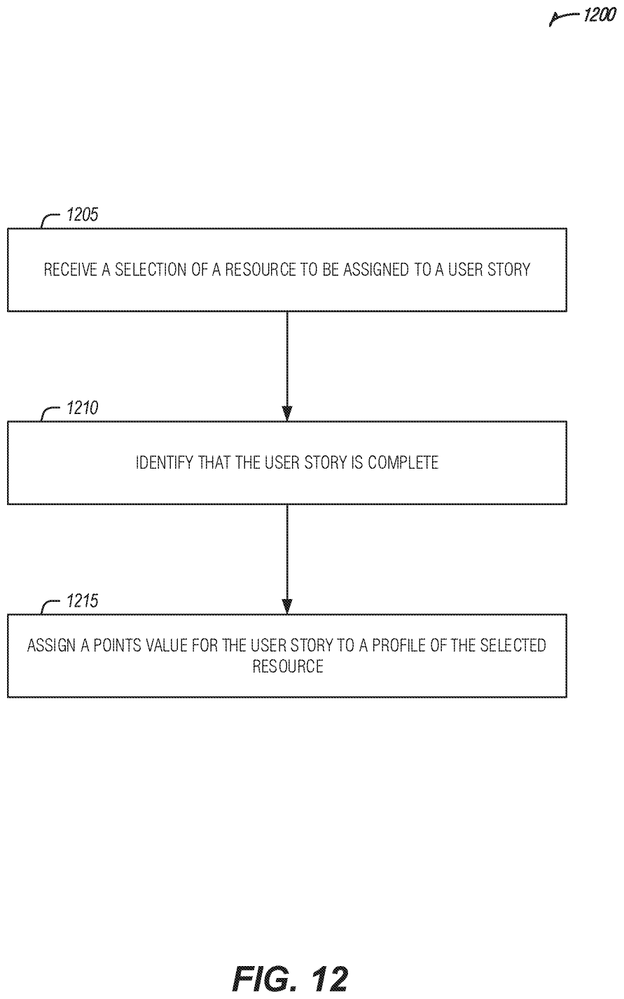

FIG. 12 illustrates an example of a method 1300 for a predictive sourcing platform, according to an embodiment. The method 1300 may provide features as described in FIGS. 1-12.

At operation 1205, a selection of a resource from the set of resources may be received. In an example, the selection of the resource may be received from a graphical user interface.

At operation 1210, it may be identified that the user story is complete. At operation 1215, the points value may be assigned to a profile of the selected resource. In an example, a team member group may be determined for the user story and a team member group score maybe updated for the selected resource based on the team member group and identification that the user story is complete.

In an example, a new points total may be calculated for the selected resource. It may be determined that the new points total qualifies the selected resource for a new title and the profile of the resource may be updated with the new title. In another example, a new points total may be calculated for the selected resource. It may be determined that the new points total qualifies the selected resource for a new badge and the profile of the resource may be updated with the new badge. In yet another example, a new points total may be calculated for the selected resource. It may be determined that the new points total alters a leaderboard for the predictive sourcing platform and the leaderboard may be updated with the new points total and identification of the selected resource.

In an example, a rewards user interface may be transmitted to the resource. A selection of a reward may be received via the rewards user interface. It may be determined that a reward point value for the reward is less than or equal to a points total available in the profile of the selected resource. The reward point value may be deducted from the points total and the reward may be submitted for fulfillment.

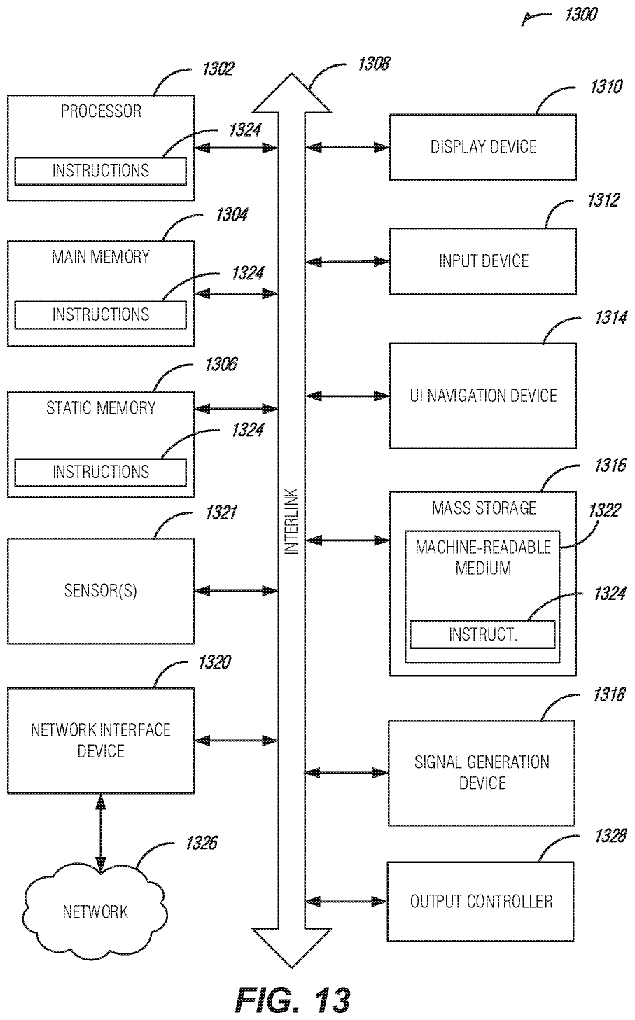

FIG. 13 illustrates a block diagram of an example machine 1300 upon which any one or more of the techniques (e.g., methodologies) discussed herein may perform. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a display unit 1310, an alphanumeric input device 1312 (e.g., a keyboard), and a user interface (UI) navigation device 1314 (e.g., a mouse). In an example, the display unit 1310, input device 1312 and UI navigation device 1314 may be a touch screen display. The machine 1300 may additionally include a storage device (e.g., drive unit) 1316, a signal generation device 1318 (e.g., a speaker), a network interface device 1320, and one or more sensors 1321, such as a global positioning system (GPS) sensor, compass, accelerometer, or other sensors. The machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the storage device 1316 may constitute machine readable media.

While the machine readable medium 1322 is illustrated as a single medium, the term “machine readable medium” may include a single medium or multiple media (e.g., a centralized or distributed database, and/or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1300, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for a predictive sourcing platform comprising:
at least one processor; and
memory including instructions that, when executed by the at least one processor, cause the at least one processor to perform operations to:
extract features from a corpus of training data obtained from a plurality of data sources;
train a predictive machine learning model using the extracted features;
receive user story data that includes user story attributes that describe constraints for completion of a task of a user story associated with the user story data and a points value for the user story;
present a user interface to a resource including content generated in part by a gamification model;
modify a points total for the resource based on metrics based on interaction of the resource with the user interface;
automatically assign a gamification title for the resource based on the points total using the gamification model;
store input received via the user interface and the gamification title in resource profile data of a resource profile for the resource;
receive the resource profile data that includes resource attributes that describe resources, wherein the resource attributes include a user interest resource attribute or diversity resource attribute;
evaluate the user story attributes and the resource attributes using the predictive machine learning model to predict a resource requirement for completion of the task;
select a set of resources by evaluating the resource requirement using a stretching predictive machine learning model, wherein the stretching predictive machine learning model identifies suboptimal resources for inclusion in the set of resources, wherein the stretching predictive machine learning model includes a title feature, and wherein a resource is included in the set of resources at least in part based on the assigned gamification title;
receive a selection of a resource from the set of resources based on the user interest resource attribute or diversity resource attribute of the resource;
identify that the user story is complete;
assign the points value to a profile of the selected resource; and
update profile data of the resource included in the resource profile data using the points value.

2. The system of claim 1, the memory further comprising instructions that, when executed by the at least one processor, cause the at least one processor to perform operations to:
calculate a new points total for the selected resource;
determine that the new points total qualifies the selected resource for a new title; and
update the profile of the resource with the new title.

3. The system of claim 1, the memory further comprising instructions that, when executed by the at least one processor, cause the at least one processor to perform operations to:
calculate a new points total for the selected resource;
determine that the new points total qualifies the selected resource for a new badge; and
update the profile of the resource with the new badge.

4. The system of claim 1, the memory further comprising instructions that, when executed by the at least one processor, cause the at least one processor to perform operations to:
calculate a new points total for the selected resource;
determine that the new points total alters a leaderboard for the predictive sourcing platform; and
update the leaderboard with the new points total and identification of the selected resource.

5. The system of claim 1, the memory further comprising instructions that, when executed by the at least one processor, cause the at least one processor to perform operations to:
transmit the set of resources to an owner of the user story via a graphical user interface; and
receive the selection of the resource via the graphical user interface.

6. The system of claim 1 the memory further comprising instructions that, when executed by the at least one processor, cause the at least one processor to perform operations to:
transmit a rewards user interface to the resource;
receive a selection of a reward via the rewards user interface;
determine that a reward point value for the reward is less than or equal to a points total available in the profile of the selected resource;
deduct the reward point value from the points total; and
submit the reward for fulfillment.

7. The system of claim 1, the memory further comprising instructions that, when executed by the at least one processor, cause the at least one processor to perform operations to:
determine a team member group for the user story; and
update a team member group score for the selected resource based on the team member group and identification that the user story is complete.

8. At least one non-transitory machine-readable medium including instructions for a predictive sourcing platform that, when executed by at least one processor, cause the at least one processor to perform operations to:
extract features from a corpus of training data obtained from a plurality of data sources;
train a predictive machine learning model using the extracted features;
receive user story data that includes user story attributes that describe constraints for completion of a task of a user story associated with the user story data and a points value for the user story;
present a user interface to a resource including content generated in part by a gamification model;
modify a points total for the resource based on metrics based on interaction of the resource with the user interface;
automatically assign a gamification title for the resource based on the points total using the gamification model;
store input received via the user interface and the gamification title in resource profile data of a resource profile for the resource;
receive the resource profile data that includes resource attributes that describe resources, wherein the resource attributes include a user interest resource attribute or diversity resource attribute;
evaluate the user story attributes and the resource attributes using the predictive machine learning model to predict a resource requirement for completion of the task;
select a set of resources by evaluating the resource requirement using a stretching predictive machine learning model, wherein the stretching predictive machine learning model identifies suboptimal resources for inclusion in the set of resources, wherein the stretching predictive machine learning model includes a title feature, and wherein a resource is included in the set of resources at least in part based on the assigned gamification title;
receive a selection of a resource from the set of resources based on the user interest resource attribute or diversity resource attribute of the resource;
identify that the user story is complete;
assign the points value to a profile of the selected resource; and
update profile data of the resource included in the resource profile data using the points value.

9. The at least one non-transitory machine-readable medium of claim 8, further comprising instructions that, when executed by the at least one processor, cause the at least one processor to perform operations to:
calculate a new points total for the selected resource;
determine that the new points total qualifies the selected resource for a new title; and
update the profile of the resource with the new title.

10. The at least one non-transitory machine-readable medium of claim 8, further comprising instructions that, when executed by the at least one processor, cause the at least one processor to perform operations to:
calculate a new points total for the selected resource;
determine that the new points total qualifies the selected resource for a new badge; and
update the profile of the resource with the new badge.

11. The at least one non-transitory machine-readable medium of claim 8, further comprising instructions that, when executed by the at least one processor, cause the at least one processor to perform operations to:
calculate a new points total for the selected resource;
determine that the new points total alters a leaderboard for the predictive sourcing platform; and
update the leaderboard with the new points total and identification of the selected resource.

12. The at least one non-transitory machine-readable medium of claim 8, further comprising instructions that, when executed by the at least one processor, cause the at least one processor to perform operations to:
transmit the set of resources to an owner of the user story via a graphical user interface; and
receive the selection of the resource via the graphical user interface.

13. The at least one non-transitory machine-readable medium of claim 8 further comprising instructions that, when executed by the at least one processor, cause the at least one processor to perform operations to:
transmit a rewards user interface to the resource;
receive a selection of a reward via the rewards user interface;
determine that a reward point value for the reward is less than or equal to a points total available in the profile of the selected resource;
deduct the reward point value from the points total; and
submit the reward for fulfillment.

14. The at least one non-transitory machine-readable medium of claim 8, further comprising instructions that, when executed by the at least one processor, cause the at least one processor to perform operations to:
determine a team member group for the user story; and
update a team member group score for the selected resource based on the team member group and identification that the user story is complete.

15. A method for a predictive sourcing platform comprising:
extracting features from a corpus of training data obtained from a plurality of data sources;
training a predictive machine learning model using the extracted features;
receiving user story data that includes user story attributes that describe constraints for completion of a task of a user story associated with the user story data and a points value for the user story;
presenting a user interface to a resource including content generated in part by a gamification model;
modifying a points total for the resource based on metrics based on interaction of the resource with the user interface;
automatically assigning a gamification title for the resource based on the points total using the gamification model;
storing input received via the user interface and the gamification title in resource profile data of a resource profile for the resource;
receiving the resource profile data that includes resource attributes that describe resources, wherein the resource attributes include a user interest resource attribute or diversity resource attribute;
evaluating the user story attributes and the resource attributes using the predictive machine learning model to predict a resource requirement for completion of the task;
selecting a set of resources by evaluating the resource requirement using a stretching predictive machine learning model, wherein the stretching predictive machine learning model identifies suboptimal resources for inclusion in the set of resources, wherein the stretching predictive machine learning model includes a title feature, and wherein a resource is included in the set of resources at least in part based on the assigned gamification title;
receiving a selection of a resource from the set of resources based on the user interest resource attribute or diversity resource attribute of the resource;
identifying that the user story is complete;
assigning the points value to a profile of the selected resource; and
updating profile data of the resource included in the resource profile data using the points value.

16. The method of claim 15, further comprising:
calculating a new points total for the selected resource;
determining that the new points total qualifies the selected resource for a new title; and
updating the profile of the resource with the new title.

17. The method of claim 15, further comprising:
calculating a new points total for the selected resource;
determining that the new points total qualifies the selected resource for a new badge; and
updating the profile of the resource with the new badge.

18. The method of claim 15, further comprising:
calculating a new points total for the selected resource;
determining that the new points total alters a leaderboard for the predictive sourcing platform; and
updating the leaderboard with the new points total and identification of the selected resource.

19. The method of claim 15, further comprising:
transmitting the set of resources to an owner of the user story via a graphical user interface; and
receiving the selection of the resource via the graphical user interface.

20. The method of claim 15 further comprising:
transmitting a rewards user interface to the resource;
receiving a selection of a reward via the rewards user interface;
determining that a reward point value for the reward is less than or equal to a points total available in the profile of the selected resource;
deducting the reward point value from the points total; and
submitting the reward for fulfillment.

21. The method of claim 15, further comprising:
determining a team member group for the user story; and
updating a team member group score for the selected resource based on the team member group and identification that the user story is complete.
